(19) United States
(12) Patent Application Publication
(10) Pub. No.: US 2025/0357512 A1
(43) Pub. Date: Nov. 20, 2025

(54) REGENERATIVE FUEL CELL SYSTEM

(71) Applicant: TOYOTA JIDOSHA KABUSHIKI KAISHA, Toyota-shi (JP)

(72) Inventors: Kazuhiko KOHARI, Shizuoka-ken (JP); Yoshihiro Shinozaki, Atsugi-shi (JP)

(73) Assignee: TOYOTA JIDOSHA KABUSHIKI KAISHA, Toyota-shi (JP)

(21) Appl. No.: 19/188,228

(22) Filed: Apr. 24, 2025

(30) Foreign Application Priority Data
May 15, 2024 (JP) 2024-079045

(51) Int. Cl. H01M 8/04746; B64G 1/16; B64G 1/42; H01M 8/04119; H01M 8/04701; H01M 8/0656

(52) U.S. Cl. CPC H01M 8/04761; B64G 1/16; B64G 1/423; H01M 8/04156; H01M 8/04716; H01M 8/0656; H01M 2250/20

(57) ABSTRACT

The regenerative fuel cell system includes a fuel cell, a water tank that stores water discharged from the fuel cell, a recombiner that is disposed in the water tank and generates water by combining hydrogen and oxygen, and a water electrolyzer that generates hydrogen and oxygen by electrolyzing the water supplied from the water tank. The internal pressure of the water tank storing the water is lower than the internal pressure of the fuel cell during power generation and the internal pressure of the water electrolyzer during electrolysis.

### CROSS-REFERENCE TO RELATED APPLICATION

This application claims priority to Japanese Patent Application No. 2024-079045 filed on May 15, 2024, incorporated herein by reference in its entirety.

### BACKGROUND

### 1. Technical Field

The present disclosure relates to a regenerative fuel cell system.

### 2. Description of Related Art

There is known a regenerative fuel cell system including a fuel cell that generates power using hydrogen and oxygen, and a water electrolyzer that produces hydrogen and oxygen by electrolyzing water that is produced during power generation by the fuel cell (e.g., Japanese Patent No. 7260045).

### SUMMARY

The water discharged from the fuel cell contains hydrogen. When the water containing hydrogen is supplied to an anode of the water electrolyzer, the oxygen that is produced at the anode of the water electrolyzer reacts with the hydrogen and returns to water, and accordingly production efficiency of oxygen by the water electrolyzer decreases.

The present disclosure can be carried out according to the following aspects.

According to one aspect of the present disclosure, a regenerative fuel cell system is provided. This regenerative fuel cell system includes
a fuel cell,
a water tank that stores water that is discharged from the fuel cell,
a recombiner that is disposed in the water tank, and that combines hydrogen and oxygen to produce water, and
a water electrolyzer that produces hydrogen and oxygen by electrolyzing water that is supplied from the water tank.

Internal pressure of the water tank that stores water is lower than internal pressure of the fuel cell during power generation and internal pressure of the water electrolyzer during electrolysis.

According to the regenerative fuel cell system of this aspect, the amount of hydrogen that is contained in the water supplied from the water tank to the water electrolyzer can be reduced. Accordingly, a decrease in production efficiency of oxygen by the water electrolyzer can be suppressed.

In the regenerative fuel cell system of the above aspect, the recombiner may be disposed in an upper portion of the water tank.

According to the regenerative fuel cell system of this aspect, hydrogen and oxygen that have been separated from the water and have traveled to the upper portion within the water tank can be converted into water by the recombiner. Accordingly, the amount of hydrogen contained in the water in the water tank can be effectively reduced.

The regenerative fuel cell system of the above aspect may further include a temperature controller that adjusts temperature of the water tank.

According to the regenerative fuel cell system of this aspect, saturated vapor pressure in the water tank can be suppressed from changing. Also, the water can be suppressed from freezing in the water tank.

The regenerative fuel cell system according to the above aspect may be installed in a lunar surface vehicle that travels over a lunar surface, and may further include a valve for switching a state of the water tank to one of a communicating state in which the water tank communicates with external space that is outside of the lunar surface vehicle and a non-communicating state in which the water tank and the external space do not communicate. The valve may switch the state of the water tank to the communicating state when the lunar surface vehicle is situated on the lunar surface, and switch the state of the water tank to the non-communicating state before water flows from the fuel cell into the water tank. According to the regenerative fuel cell system of this aspect, the internal pressure of the water tank can be reduced by opening and closing the valve on the lunar surface. Thus, the internal pressure of the water tank can be reduced with a simple configuration. The present disclosure can be carried out in various forms other than the regenerative fuel cell system. For example, the present disclosure can be realized in a form of a lunar surface vehicle or the like.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view of a lunar surface vehicle equipped with a regenerative fuel cell system;

FIG. 2 is a schematic diagram of a regenerative fuel cell system; and

FIG. 3 is a schematic view of a water tank.

### DETAILED DESCRIPTION OF EMBODIMENTS

### A. First Embodiment

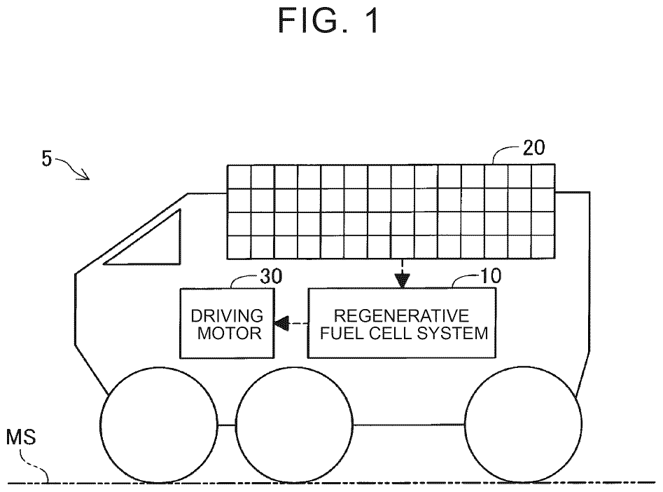

FIG. 1 is a schematic view of a lunar surface vehicle 5 equipped with a regenerative fuel cell system 10 according to a first embodiment of the present disclosure. The lunar surface vehicle 5 is a vehicle configured to be able to travel on the lunar surface MS. In the present embodiment, the lunar surface vehicle 5 includes a regenerative fuel cell system 10, a photovoltaic power generation system 20, and a traction motor 30. The regenerative fuel cell system 10 can generate hydrogen and oxygen by electrolyzing water using electric power supplied from the photovoltaic power generation system 20 during the daytime of the month, and can generate power using hydrogen and oxygen and generate water during the night of the month. The regenerative fuel cell system 10 can also generate electricity and water using hydrogen and oxygen during the day of the month. The lunar surface vehicle 5 travels on the lunar surface MS by driving the traction motor 30 using the electric power supplied from the regenerative fuel cell system 10.

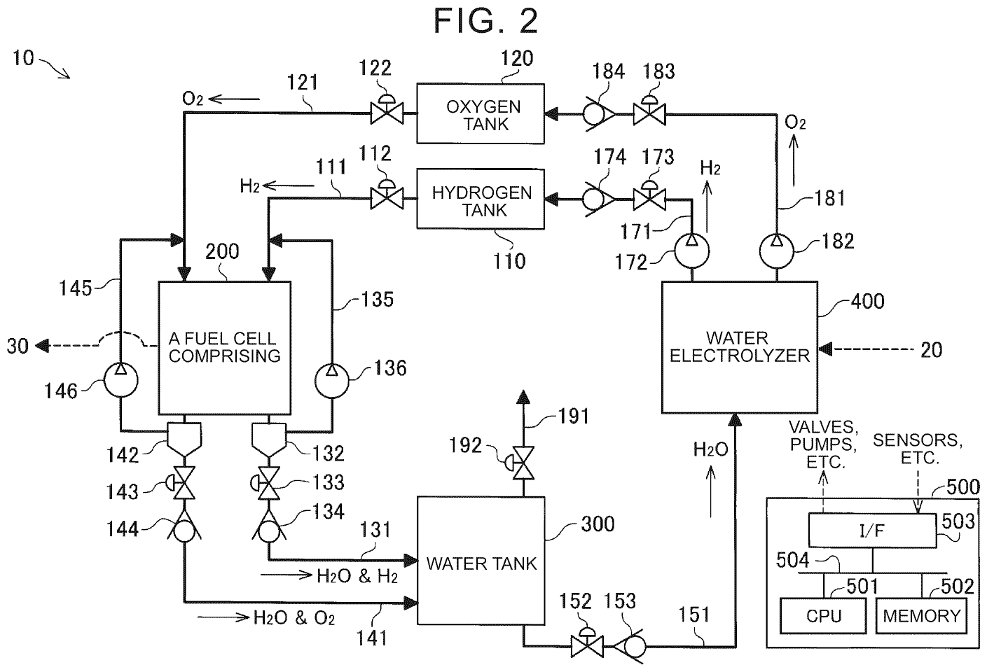

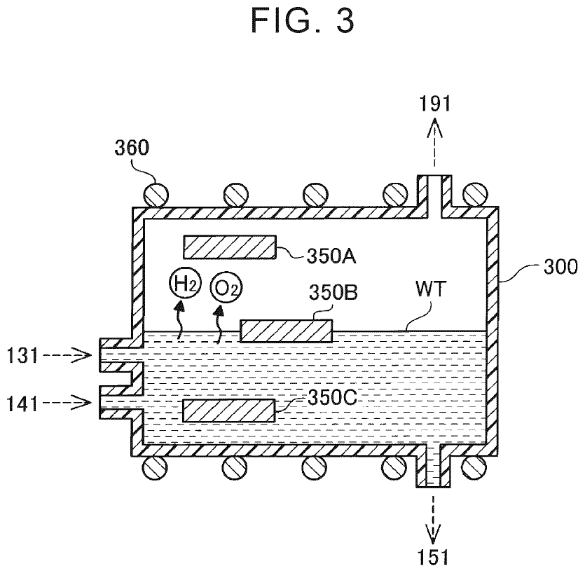

FIG. 2 is a schematic diagram of a regenerative fuel cell system 10. FIG. 3 is a schematic diagram of a water tank 300. As illustrated in FIG. 2, the regenerative fuel cell system 10 includes a hydrogen tank 110, an oxygen tank 120, a fuel cell 200, a water tank 300, a water electrolyzer 400, and a control device 500.

The hydrogen tank 110 stores hydrogen. The hydrogen tank 110 is connected to the hydrogen inlet of the fuel cell 200 via a hydrogen supply passage 111. The hydrogen supply passage 111 is provided with a hydrogen supply valve 112 for adjusting a supply amount of hydrogen supplied from the hydrogen tank 110 to the fuel cell 200. The hydrogen supply valve 112 is constituted by, for example, an electric valve or a solenoid valve. The hydrogen supply valve 112 is opened and closed under the control of the control device 500.

Oxygen is stored in the oxygen tank 120. The oxygen tank 120 is connected to an oxygen inlet of the fuel cell 200 via an oxygen supply path 121. The oxygen supply path 121 is provided with an oxygen supply valve 122 for adjusting the supply amount of oxygen supplied from the oxygen tank 120 to the fuel cell 200. The oxygen supply valve 122 is constituted by, for example, an electric valve or a solenoid valve. The oxygen supply valve 122 is opened and closed under the control of the control device 500.

The fuel cell 200 generates electric power using hydrogen and oxygen. In the present embodiment, a polymer electrolyte fuel cell is used for the fuel cell 200. The fuel cell 200 includes a fuel cell stack in which a plurality of fuel cells are stacked. Each fuel cell includes a membrane electrode assembly in which electrode catalyst layers are provided on both surfaces of an electrolyte membrane, and a separator that sandwiches the membrane electrode assembly. The fuel cell 200 generates electricity by supplying hydrogen to the electrode catalyst layer on the anode side and oxygen to the electrode catalyst layer on the cathode side. Water is generated as the fuel cell 200 generates electricity. The electric power generated by the fuel cell 200 is used to drive the traction motor 30.

The hydrogen outlet of the fuel cell 200 is connected to the water tank 300 via a hydrogen side drain passage 131. In the hydrogen-side drain passage 131, a hydrogen-side gas-liquid separator 132, a hydrogen-side drain valve 133, and a hydrogen-side check valve 134 are provided in this order from the fuel cell 200 toward the water tank 300. Hydrogen and water are discharged from the hydrogen outlet of the fuel cell 200. The hydrogen-side gas-liquid separator 132 stores hydrogen and water discharged from the hydrogen outlet of the fuel cell 200, and separates the hydrogen from the water. In the present embodiment, the hydrogen-side gas-liquid separator 132 is connected to the hydrogen supply passage 111 via the hydrogen circulation path 135. A hydrogen circulation pump 136 is provided in the hydrogen circulation path 135. The hydrogen circulation pump 136 pumps hydrogen from the hydrogen-side gas-liquid separator 132 to the hydrogen supply passage 111 via the hydrogen circulation path 135. The hydrogen circulation pump 136 is driven under the control of the control device 500. The hydrogen-side drain valve 133 adjusts the amount of water discharged from the hydrogen-side gas-liquid separator 132 to the water tank 300. The hydrogen-side drain valve 133 is constituted by, for example, an electrically operated valve or a solenoid valve. The hydrogen-side drain valve 133 is opened and closed under the control of the control device 500. Although not shown, in the present embodiment, the hydrogen-side gas-liquid separator 132 is provided with a water level sensor for detecting the water level of the hydrogen-side gas-liquid separator 132. The control device 500 opens the hydrogen-side drain valve 133 when the water level of the hydrogen-side gas-liquid separator 132 detected by the water level sensor is equal to or higher than a predetermined value, and closes the hydrogen-side drain valve 133 when the water level of the hydrogen-side gas-liquid separator 132 detected by the water level sensor is lower than the predetermined value. Therefore, the hydrogen separated from the water is prevented from flowing from the hydrogen-side gas-liquid separator 132 into the water tank 300. The hydrogen-side check valve 134 suppresses backflow of water from the water tank 300 to the hydrogen-side gas-liquid separator 132.

The oxygen outlet of the fuel cell 200 is connected to the water tank 300 via the oxygen-side drain passage 141. In the oxygen-side drain passage 141, an oxygen-side gas-liquid separator 142, an oxygen-side drain valve 143, and an oxygen-side check valve 144 are provided in this order from the fuel cell 200 toward the water tank 300. Oxygen and water are discharged from the oxygen outlet of the fuel cell 200. The oxygen-side gas-liquid 20 separator 142 stores oxygen and water discharged from the oxygen outlet of the fuel cell 200, and separates the oxygen from the water. In the present embodiment, the oxygen-side gas-liquid separator 142 is connected to the oxygen supply path 121 via the oxygen circulation path 145. An oxygen circulation pump 146 is provided in the oxygen circulation path 145. The oxygen circulation pump 146 pumps oxygen from the oxygen-side gas-liquid separator 142 to the oxygen supply path 121 via the oxygen circulation path 145. The oxygen circulation pump 146 is driven under the control of the control device 500. The oxygen-side drain valve 143 adjusts the amount of water discharged from the oxygen-side gas-liquid separator 142 to the water tank 300. The oxygen-side drain valve 143 is constituted by, for example, an electrically operated valve or a solenoid valve. The oxygen-side drain valve 143 is opened and closed under the control of the control device 500. Although not shown, in the present embodiment, the oxygen-side gas-liquid separator 142 is provided with a water level sensor for detecting the water level of the oxygen-side gas-liquid separator 142. The control device 500 opens the oxygen-side drain valve 143 when the water level of the oxygen-side gas-liquid separator 142 detected by the water level sensor is equal to or higher than a predetermined value, and closes the oxygen-side drain valve 143 when the water level of the oxygen-side gas-liquid separator 142 detected by the water level sensor is lower than the predetermined value. Therefore, oxygen separated from the water is prevented from flowing from the oxygen-side gas-liquid separator 142 into the water tank 300. The oxygen-side check valve 144 suppresses backflow of water from the water tank 300 to the oxygen-side gas-liquid separator 142.

The water tank 300 stores the water discharged from the fuel cell 200. As shown in FIG. 3, at least one recombiner 350 is disposed within the water tank 300. In the present embodiment, three recombiners 350 are arranged in the water tank 300. The recombiner 350 combines hydrogen and oxygen to produce water. In the present embodiment, a catalytic recombiner is used as the recombiner 350. In the following discussion, to distinguish the three recombiners 350, the first recombiner 350 may be referred to as a first recombiner 350A, the second recombiner 350 may be referred to as a second recombiner 350B, and the third recombiner 350 may be referred to as a third recombiner 350C. When three recombiners 350 are described without particular distinction, they are simply referred to as recombiners 350.

The first recombiner 350A is located at the top of the water tank 300 so as to be located above the water. The upper portion in the water tank 300 is a portion above the center of the water tank 300 in the up-down direction. The first recombiner 350A is fixed to, for example, a ceiling surface of the water tank 300 or a side wall surface of the water tank 300. The second recombiner 350B is disposed near the center in the vertical direction in the water tank 300 so as to be located near the water surface. The second recombiner 350B is fixed, for example, to the side wall surface of the water tank 300. However, the second recombiner 350B may not be fixed to the water tank 300. The second recombiner 350B may, for example, be configured to float in water and move up and down in the water tank 300. The third recombiner 350C is disposed in the lower portion of the water tank 300 so as to be located in the water. The lower portion in the water tank 300 is a portion lower than the center of the water tank 300 in the up-down direction. The third recombiner 350C is fixed to, for example, the floor surface of the water tank 300 or the side wall surface of the water tank 300. However, the third recombiner 350C may not be fixed to the water tank 300.

The water tank 300 is provided with a temperature controller 360 for adjusting the temperature in the water tank 300. The temperature controller 360 adjusts the temperature in the water tank 300 under the control of the control device 500. In the present embodiment, the temperature controller 360 includes a pipe through which the heat medium flows, a heat exchanger that exchanges heat with the heat medium, a pump that pumps the heat medium, and the like. However, the temperature controller 360 may be configured by a heater that generates heat by receiving power.

As shown in FIG. 2, the water tank 300 is connected to a water inlet of the water electrolyzer 400 via a water supply path 151. The water supply path 151 is provided with a water supply valve 152 and a water supply check valve 153 from the water tank 300 toward the water electrolyzer 400. The water supply valve 152 adjusts a supply amount of water supplied from the water tank 300 to the water electrolyzer 400. The water supply valve 152 is constituted by, for example, an electrically operated valve or a solenoid valve. The water supply valve 152 is opened and closed under the control of the control device 500. Although not shown, in the present embodiment, the water tank 300 is provided with a water level sensor for detecting the water level in the water tank 300. The control device 500 opens the water supply valve 152 when the water level of the water tank 300 detected by the water level sensor is equal to or higher than a predetermined value, and closes the water supply valve 152 when the water level of the water tank 300 detected by the water level sensor is lower than the predetermined value. Therefore, hydrogen and oxygen separated from the water are prevented from flowing from the water tank 300 into the water electrolyzer 400. The water supply check valve 153 suppresses backflow of water from the water electrolyzer 400 to the water tank 300.

In the present embodiment, the water tank 300 communicates with the external space of the lunar surface vehicle 5 via the exhaust passage 191, in other words, the external space of the regenerative fuel cell system 10. An exhaust valve 192 is provided in the exhaust passage 191. The exhaust valve 192 switches the state of the water tank 300 to any one of a communication state in which the inside of the water tank 300 communicates with the outside space of the lunar surface vehicle 5, and a non-communication state in which the inside of the water tank 300 and the outside space of the lunar surface vehicle 5 do not communicate with each other. When the exhaust valve 192 is opened, the water tank 300 is brought into communication, and when the exhaust valve 192 is closed, the water tank 300 is brought into non-communication. The exhaust valve 192 is constituted by, for example, an electrically operated valve or a solenoid valve. The exhaust valve 192 is opened and closed under the control of the control device 500.

The water electrolyzer 400 generates hydrogen and oxygen by electrolyzing the water supplied from the water tank 300. In the present embodiment, a solid polymer type water electrolyzer is used for the water electrolyzer 400. The water electrolyzer 400 includes a water electrolysis stack in which a plurality of water electrolysis cells are stacked, and a pump that pumps water from the water supply path 151 to the water electrolysis stack. Each water electrolysis cell includes a membrane electrode assembly in which electrode catalyst layers are provided on both surfaces of an electrolyte membrane, and a separator that sandwiches the membrane electrode assembly. The water electrolyzer 400 electrolyzes the water supplied to the electrode catalyst layer on the anode side, thereby generating oxygen in the electrode catalyst layer on the anode side and generating hydrogen in the electrode catalyst layer on the cathode side. In the present embodiment, the water electrolyzer 400 electrolyzes water using the electric power supplied from the photovoltaic power generation system 20. However, the water electrolyzer 400 may electrolyze water using electric power supplied from a power supply source other than the photovoltaic power generation system 20 such as a lithium ion secondary battery, for example.

The hydrogen outlet of the water electrolyzer 400 is connected to the hydrogen tank 110 via a hydrogen filling passage 171. In the hydrogen filling passage 171, a hydrogen filling pump 172, a hydrogen filling valve 173, and a hydrogen filling check valve 174 are provided in this order from the water electrolyzer 400 toward the hydrogen tank 110. The hydrogen filling pump 172 pumps hydrogen from the water electrolyzer 400 to the hydrogen tank 110. The hydrogen filling pump 172 is driven under the control of the control device 500. The hydrogen filling valve 173 adjusts the supply amount of hydrogen supplied from the water electrolyzer 400 to the hydrogen tank 110. The hydrogen filling valve 173 is constituted by, for example, an electric valve or a solenoid valve. The hydrogen filling valve 173 is opened and closed under the control of the control device 500. The hydrogen filling check valve 174 suppresses backflow of hydrogen from the hydrogen tank 110 to the water electrolyzer 400. The regenerative fuel cell system 10 may further include a gas-liquid separator that separates the hydrogen discharged from the hydrogen outlet of the water electrolyzer 400 and the water, and a circulation path and a pump that circulate the water separated from the hydrogen by the gas-liquid separator to the water supply path 151.

The oxygen outlet of the water electrolyzer 400 is connected to the oxygen tank 120 via an oxygen filling path 181. In the oxygen filling path 181, an oxygen filling pump 182, an oxygen filling valve 183, and an oxygen filling check valve 184 are provided in this order from the water electrolyzer 400 toward the oxygen tank 120. The oxygen filling pump 182 pumps oxygen from the water electrolyzer 400 to the oxygen tank 120. The oxygen filling pump 182 is driven under the control of the control device 500. The oxygen filling valve 183 adjusts the supply amount of oxygen supplied from the water electrolyzer 400 to the oxygen tank 120. The oxygen filling valve 183 is constituted by, for example, an electrically operated valve or a solenoid valve. The oxygen filling valve 183 is opened and closed under the control of the control device 500. The oxygen-filling check valve 184 suppresses backflow of oxygen from the oxygen tank 120 to the water electrolyzer 400. The regenerative fuel cell system 10 may further include a gas-liquid separator that separates the oxygen and the water discharged from the oxygen outlet of the water electrolyzer 400, and a circulation path and a pump that circulate the water separated from the oxygen by the gas-liquid separator to the water supply path 151.

The control device 500 includes a computer including a CPU 501, a memory 502 including a ROM, a RAM, and the like, an input/output interface 503, and an internal bus 504. CPU 501, the memory 502, and the input/output interfaces 503 are connected to each other via an internal bus 504 so as to be capable of two-way communication. Various valves, various pumps, various sensors, and the like of the above-described regenerative fuel cell system 10 are connected to the input/output interface 503 via wired communication or wireless communication. CPU 501 performs various functions including a function of controlling power generation by the fuel cell 200 and a function of controlling electrolysis of water by the water electrolyzer 400 by executing a computer program stored in advance in the memory 502.

The control device 500 controls each part of the regenerative fuel cell system 10 so that the internal pressure of the water tank 300 storing water is lower than the internal pressure of the fuel cell 200 generating electricity and lower than the internal pressure of the water electrolyzer 400 during electrolysis of water. Specifically, the control device 500 opens the exhaust valve 192 after the lunar surface vehicle 5 arrives at the lunar surface M S. The lunar surface vehicle 5 is transported from the earth to the lunar surface M S while the water tank 300 is empty, in other words, when no liquid such as water is present in the water tank 300. On the lunar surface MS, since the external space of the lunar surface vehicle 5 is in a vacuum state, the exhaust valve 192 is opened on the lunar surface MS, so that the air in the water tank 300 is discharged to the external space, and the inside of the water tank 300 is brought into a vacuum state. The control device 500 closes the exhaust valve 192 after the inside of the water tank 300 is in a vacuum state. Although not shown, in the present embodiment, the water tank 300 is provided with a pressure sensor for detecting the pressure in the water tank 300, and the control device 500 can determine whether or not the inside of the water tank 300 is in a vacuum state by using the pressure sensor. In the present embodiment, while the exhaust valve 192 is open, the hydrogen side drain valve 133, the oxygen side drain valve 143, and the water supply valve 152 are closed. However, while the exhaust valve 192 is open, the hydrogen side drain valve 133, the oxygen side drain valve 143, and the water supply valve 152 may be open. Note that the exhaust valve 192 may not be opened after the lunar surface vehicle 5 arrives at the lunar surface M S, but may be opened before the lunar surface vehicle 5 arrives at the lunar surface M S.

After the exhaust valve 192 is closed, the control device 500 starts first-time power generation by the fuel cell 200. First time means the first time after the lunar surface vehicle 5 arrives at the lunar surface MS. In the present embodiment, the internal pressure of the fuel cell 200 during power generation is higher than the atmospheric pressure of the earth. When power generation of the fuel cell 200 is started, water containing hydrogen and water containing oxygen flow from the fuel cell 200 into the water tank 300 in a vacuum state. When water containing hydrogen and water containing oxygen flow into the water tank 300 in a vacuum state, water, hydrogen, and oxygen are vaporized in the water tank 300, and the internal pressure of the water tank 300 increases. Since the internal pressure of the water tank 300 does not exceed the saturated vapor pressure, when the internal pressure of the water tank 300 reaches the saturated vapor pressure, the increase of the internal pressure of the water tank 300 is stopped. When the internal pressure of the water tank 300 reaches the saturated vapor pressure, a mixed gas containing water vapor, hydrogen, and oxygen and water in which hydrogen and oxygen are dissolved coexist in the water tank 300. Here, the saturated vapor pressure varies depending on the temperature. In the present embodiment, the control device 500 controls the temperature controller 360 to keep the temperature in the water tank 300 constant. As a result, it is possible to prevent the saturated vapor pressure in the water tank 300 from changing.

Here, the nocturnal temperature at the lunar surface MS drops to approximately minus 170 degrees Celsius, so that the water may freeze in the water tank 300. Further, when water flows into the water tank 300 in a vacuum state, the water is vaporized, the temperature in the water tank 300 is lowered due to the vaporization heat, and there is a possibility that the water is frozen in the water tank 300. When the water in the water tank 300 freezes, there is a possibility that water cannot be supplied to the water electrolyzer 400. However, in the present embodiment, since the control device 500 controls the temperature controller 360 to keep the temperature in the water tank 300 constant, the temperature of the water tank 300 decreases due to the vaporization heat when the water is vaporized, and thus it is possible to prevent the water from freezing in the water tank 300.

During a period from when the power generation by the fuel cell 200 is stopped until the electrolysis of the water by the water electrolyzer 400 is started, the hydrogen-side drain valve 133, the oxygen-side drain valve 143, and the water supply valve 152 are closed, and the sealed state of the water tank 300 is maintained. Since the recombiner 350 is disposed in the water tank 300, the hydrogen partial pressure and the oxygen partial pressure of the mixed gas in the water tank 300 decrease due to the combination of the vaporized hydrogen and the oxygen. Here, hydrogen and oxygen dissolve in water according to Henry's law. According to Henry's law, a gas dissolves in water only in an amount of material proportional to its partial pressure. Therefore, the hydrogen partial pressure and the oxygen partial pressure in the water tank 300 decrease, and thus the hydrogen concentration and the oxygen concentration of the water in the water tank 300 decrease.

Thereafter, the control device 500 supplies the water stored in the water tank 300 to the water electrolyzer 400, and starts electrolysis of the water by the water electrolyzer 400. In this embodiment, the internal pressure of the water electrolyzer 400 during electrolysis of water is higher than the atmospheric pressure of the earth. Here, when the water containing hydrogen is supplied to the anode side of the water electrolyzer 400, a part of the oxygen generated on the anode side by the electrolysis of the water combines with the hydrogen and returns to the water, so that the generation efficiency of the oxygen by the water electrolyzer 400 is lowered. However, in the present embodiment, since the recombiner 350 is disposed in the water tank 300, the hydrogen concentration of the water supplied from the water tank 300 to the water electrolyzer 400 is lowered, so that it is possible to suppress a decrease in the generation efficiency of oxygen by the water electrolyzer 400.

According to the regenerative fuel cell system 10 of the present embodiment described above, the control device 500 controls each unit of the regenerative fuel cell system 10 so that the internal pressure of the water tank 300 during storage of water is lower than the internal pressure of the fuel cell 200 and lower than the internal pressure of the water electrolyzer 400. Therefore, hydrogen and oxygen dissolved in the water can be easily vaporized in the water tank 300. Further, in the present embodiment, a recombiner 350 that combines hydrogen and oxygen to generate water is disposed in the water tank 300. Therefore, the amount of hydrogen contained in the water supplied from the water tank 300 to the water electrolyzer 400 can be reduced by using the vaporized hydrogen and oxygen in the water tank 300 as water. Therefore, it is possible to suppress a decrease in the generation efficiency of oxygen by the water electrolyzer 400.

Here, a mixed gas containing a large amount of hydrogen and oxygen may be intensely fueled, and therefore, it is not preferable that a mixed gas containing a large amount of hydrogen and oxygen be present in the regenerative fuel cell system 10. However, in the present embodiment, the internal pressure of the water tank 300 in the water flow path from the fuel cell 200 to the water electrolyzer 400 is lower than the internal pressure of a portion other than the water tank 300. Therefore, it is possible to suppress generation of a mixed gas containing a large amount of hydrogen and oxygen in a portion other than the water tank 300.

In the present embodiment, three recombiners 350A to 350C are disposed in the water tank 300. The first recombiner 350A disposed in the upper portion of the water tank 300 allows hydrogen and oxygen accumulated in the upper portion of the water tank 300 to be vaporized into water. The second recombiner 350B disposed between the first recombiner 350A and the third recombiner 350C allows the hydrogen and oxygen to become water at an early stage near the water surface prior to the hydrogen and oxygen moving to the top of the water tank 300. The third recombiner 350C located in the lower portion of the water tank 300 allows the hydrogen and oxygen to become water early in the water. Therefore, by arranging the recombiners 350A to 350C at a plurality of locations in the water tank 300, the hydrogen content in the water tank 300 can be effectively reduced.

Further, in the present embodiment, an exhaust valve 192 for switching between communication and non-communication between the inside of the water tank 300 and the external space of the lunar surface vehicle 5 is provided. Therefore, by opening the exhaust valve 192, the inside of the water tank 300 and the external space on the lunar surface M S can be made to communicate with each other, and the inside of the water tank 300 can be evacuated. Therefore, the inside of the water tank 300 can be brought into a vacuum state with a simple configuration.

Further, in the present embodiment, a temperature controller 360 for adjusting the temperature in the water tank 300 is provided. Therefore, by keeping the temperature in the water tank 300 constant, it is possible to suppress a change in the saturated vapor pressure in the water tank 300. Further, by keeping the temperature in the water tank 300 constant, it is possible to prevent water from being frozen in the water tank 300 and the water from being supplied to the water electrolyzer 400.

### B. Other Embodiments

(B1) In the above-described first embodiment, the regenerative fuel cell system 10 is mounted on the lunar surface vehicle 5 and is used on the lunar surface M S. In contrast, the regenerative fuel cell system 10 may be used on the earth, for example. In this case, since the inside of the water tank 300 cannot be brought into a vacuum state simply by opening the exhaust valve 192, a vacuum pump connected to the water tank 300 via the exhaust passage 191 may be provided in the regenerative fuel cell system 10, and the control device 500 may use the vacuum pump to bring the inside of the water tank 300 into a vacuum state.

(B2) In the first embodiment described above, the recombiner 350 is a catalytic recombiner. In contrast, the recombiner 350 may be a recombiner in which oxygen and hydrogen are converted into water by an oxidation reaction.

(B3) In the first embodiment described above, the number of the water tanks 300 into which the water containing hydrogen and the water containing oxygen flow is one. In contrast, the number of the water tanks 300 may be two or more. In this case, the recombiner 350 is preferably arranged in all the water tanks 300.

(B4) In the first embodiment described above, a temperature controller 360 for adjusting the temperature in the water tank 300 is provided. In contrast, the temperature controller 360 may not be provided.

(B5) In the first embodiment described above, the exhaust valve 192 is constituted by an electrically operated valve or a solenoid valve that can be opened and closed under the control of the control device 500. In contrast, the exhaust valve 192 may be a manual valve. In this case, since the exhaust valve 192 cannot be opened and closed by the control device 500, the exhaust valve 192 may be opened and closed by an occupant of the lunar surface vehicle 5, for example.

The present disclosure is not limited to the embodiments above, and can be implemented with various configurations without departing from the scope of the present disclosure. For example, the technical features of the embodiments corresponding to the technical features in each mode described in the section of the summary of the disclosure may be replaced or combined appropriately to solve some or all of the above issues or to achieve some or all of the above effects. When the technical features are not described as essential in this specification, the technical features can be deleted as appropriate.

What is claimed is:

1. A regenerative fuel cell system, comprising:
a fuel cell;
a water tank that stores water that is discharged from the fuel cell;
a recombiner that is disposed in the water tank, and that combines hydrogen and oxygen to produce water; and
a water electrolyzer that produces hydrogen and oxygen by electrolyzing water that is supplied from the water tank, wherein
internal pressure of the water tank that stores water is lower than internal pressure of the fuel cell during power generation and internal pressure of the water electrolyzer during electrolysis.

2. The regenerative fuel cell system according to claim 1, wherein the recombiner is disposed in an upper portion of the water tank.

3. The regenerative fuel cell system according to claim 1, further comprising a temperature controller that adjusts temperature of the water tank.

4. The regenerative fuel cell system according to claim 1, wherein:
the regenerative fuel cell system is installed in a lunar surface vehicle that travels over a lunar surface, and further includes a valve for switching a state of the water tank to one of a communicating state in which the water tank communicates with external space that is outside of the lunar surface vehicle and a non-communicating state in which the water tank and the external space do not communicate; and
the valve switches the state of the water tank to the communicating state when the lunar surface vehicle is situated on the lunar surface, and switches the state of the water tank to the non-communicating state before water flows from the fuel cell into the water tank.
